(19) United States
(12) Patent Application Publication
(10) Pub. No.: US 2014/0092319 A1
(43) Pub. Date: Apr. 3, 2014

(54) TELEVISION SET

(71) Applicant: Funai Electric Co., Ltd., Osaka (JP)

(72) Inventors: Takehiro ONOMATSU, Daito-shi (JP); Tomohiro YAMAMOTO, Daito-shi (JP)

(73) Assignee: Funai Electric Co., Ltd., Osaka (JP)

(21) Appl. No.: 14/031,247

(22) Filed: Sep. 19, 2013

(30) Foreign Application Priority Data
Oct. 1, 2012 (JP) 2012-219859

(51) Int. Cl. H04N 5/64

(52) U.S. Cl. CPC H04N 5/642
USPC 348/843

(57) ABSTRACT

A television set includes a television set main body that includes a display portion on its front surface and that is disposed such that its rear surface faces a wall, as well as a speaker unit for left-side audio and a speaker unit for right-side audio for the television set main body. Furthermore, the speaker unit for left-side audio and the speaker unit for right-side audio are each disposed in a space between the television set main body and the wall so as to output audio in a direction parallel or substantially parallel to the display portion of the television set main body.

### BACKGROUND OF THE INVENTION

1. Field of the Invention

The present invention relates to a television set and particularly to a television set that is disposed such that its rear surface faces a wall.

2. Description of the Related Art

Television sets disposed such that a rear surface faces a wall have been known in the past (for example, see Japanese Patent Application Laid-Open Publication No. 2008-52133).

Japanese Patent Application Laid-Open Publication No. 2008-52133 discloses a television set which is disposed such that its rear surface faces a wall and which includes a display portion on its front surface. This television set is of a thin-screen type and is secured to the wall by a wall hanging mechanism. Furthermore, speakers built into a thin-screen television set are considered to be formed thin as well.

### SUMMARY OF THE INVENTION

With the thin-screen television set of Japanese Patent Application Laid-Open Publication No. 2008-52133, however, it is considered that the built-in speakers are also formed to be thin, so there is a problem in that the quality of the sound output from the speakers ends up being diminished accordingly.

Accordingly, preferred embodiments of the present invention provide a television set that prevents any degradation of the quality of the sound output from the speakers even in cases where the main body of the television set is made to be thin.

The television set according to one aspect of a preferred embodiment of the present invention includes a television set main body that includes a display portion on its front surface and that is disposed such that its rear surface faces a wall, as well as a speaker unit for left-side audio and a speaker unit for right-side audio for the television set main body, wherein the speaker unit for left-side audio and the speaker unit for right-side audio are each disposed in a space between the television set main body and the wall so as to output audio in a direction parallel or substantially parallel to the display portion of the television set main body.

As was described above, with the television set according to one aspect of a preferred embodiment of the present invention, as a result of the speaker unit for left-side audio and the speaker unit for right-side audio being provided in the space between the television set main body and the wall so as to output audio in a direction parallel or substantially parallel to the display portion of the television set main body, the thickness of each of the speaker unit for left-side audio and the speaker unit for right-side audio can be increased within the constraints of the space between the television set main body and the wall irrespective of the thickness of the television set main body. Therefore, it is possible to prevent any degradation of the quality of the sound output from the speakers even in cases where the television set main body is made thin.

In the television set according to the aforementioned one aspect of a preferred embodiment of the present invention, it is preferable that a lattice-shaped securing member that secures the television set main body to the wall be further provided and that the speaker unit for left-side audio and the speaker unit for right-side audio be each attached to the lattice-shaped securing member. By adopting this constitution, the space arising from the use of the lattice-shaped securing member can be utilized effectively, thus making it possible to easily dispose the speaker unit for left-side audio and the speaker unit for right-side audio in the space between the television set main body and the wall.

In this case, it is preferable that the securing member include TV-side securing members attached to the television set main body and wall-side securing members attached to the wall and be also constituted such that the television set main body is secured to the wall by attaching the TV-side securing members to the wall-side securing members, and that the speaker unit for left-side audio and the speaker unit for right-side audio be respectively attached to the TV-side securing members. With such a constitution, it is possible to secure the television set main body to the wall by first attaching the television set main body, the speaker unit for left-side audio, and the speaker unit for right-side audio to the TV-side securing members and then attaching the TV-side securing members to the wall-side securing members. Therefore, the work of wiring the speaker unit for left-side audio and the speaker unit for right-side audio to the television set main body and the like can be performed easily before securing to the wall. Consequently, when the speaker unit for left-side audio and the speaker unit for right-side audio are to be installed between the television set main body and the wall, this installation work can be performed efficiently.

In a constitution including the aforementioned securing member, it is preferable that this television set also includes an amplifier unit that provides audio output to the speaker unit for left-side audio and the speaker unit for right-side audio, and that the amplifier unit be disposed in a space between the television set main body and the wall and also in a space within the lattice-shaped securing member delimited in a lattice shape. If such a constitution is adopted, the amplifier unit can easily be disposed by making effective use of the space delimited in the lattice shape by the securing member within the space between the television set main body and the wall, so the quality of the sound output from the speaker unit for left-side audio and the speaker unit for right-side audio can be improved with the use of the amplifier unit.

In a constitution including the aforementioned securing member, it is preferable that the speaker unit for left-side audio and the speaker unit for right-side audio be each disposed in a space between the television set main body and the wall and also in a space within the lattice-shaped securing member delimited in a lattice shape. With such a constitution, it is possible to easily dispose the speaker unit for left-side audio and the speaker unit for right-side audio by making effective use of the space delimited in the lattice shape by the securing member within the space between the television set main body and the wall.

In the television set according to the aforementioned one aspect of a preferred embodiment of the present invention, it is preferable that the speaker unit for left-side audio and the speaker unit for right-side audio be each disposed in a space between the television set main body and the wall and also in the vicinity of the outer edge portions of the rear surface of the television set main body. By adopting such a constitution, it is possible to prevent the sound being trapped in the space between the television set main body and the wall, so the users are able to hear the audio that is output from the speaker unit for left-side audio and the speaker unit for right-side audio in a favorable state.

In the television set according to the aforementioned one aspect of a preferred embodiment of the present invention, it is preferable that audio equipment that provides video output or recording equipment that records video be further provided, and that the audio equipment or the recording equipment be disposed in a space between the television set main body and the wall. With such a constitution, in addition to the speaker unit for left-side audio and the speaker unit for right-side audio, the audio equipment or recording equipment can easily be disposed by effectively utilizing the space between the television set main body and the wall.

With the various preferred embodiments of the present invention, as was described above, it is possible to prevent any degradation of the quality of the sound output from the speakers even in cases where the television set main body is made thin.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of the television set according to a first preferred embodiment of the present invention as seen from the front.

FIG. 2 is a perspective view of the television set according to the first preferred embodiment of the present invention as seen from the rear.

FIG. 3 is a perspective view of the television set according to the first preferred embodiment of the present invention for illustrating attachment to a wall.

FIG. 4 is a front view showing the securing member of the television set according to the first preferred embodiment of the present invention.

FIG. 5 is a perspective view of the television set according to a second preferred embodiment of the present invention as seen from the rear.

FIG. 6 is a front view showing the securing member of the television set according to a modified example of the second preferred embodiment of the present invention.

### DETAILED DESCRIPTION OF THE PREFERRED EMBODIMENTS

Preferred embodiments of the present invention will be described below based on drawings.

### First Preferred Embodiment

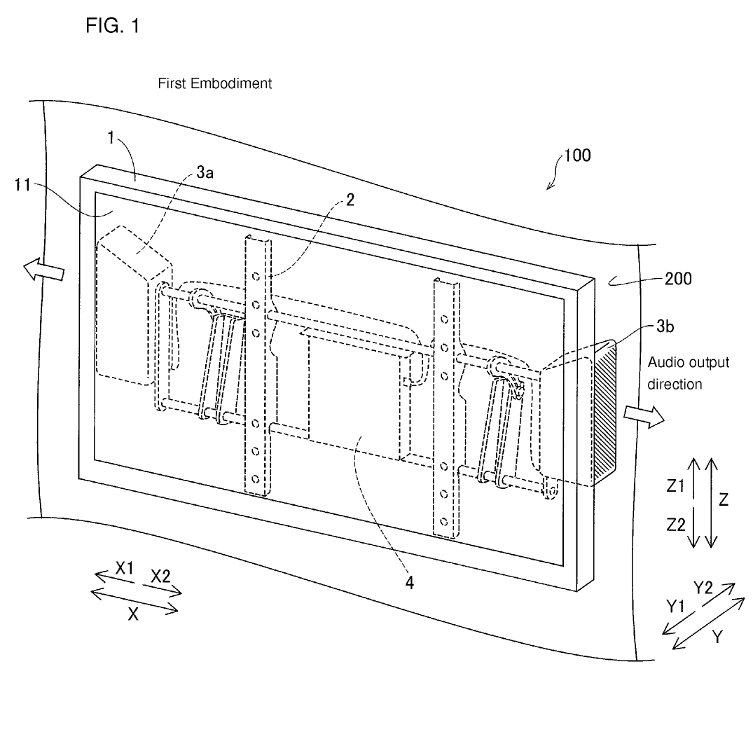

The constitution of the television set 100 according to a first preferred embodiment of the present invention will be described with reference to FIGS. 1 through 4.

As is shown in FIG. 1, the television set 100 is disposed such that it hangs on a wall 200 with its rear surface (the surface toward the Y2 direction) facing the wall. Furthermore, the television set 100 includes a television set main body 1, a securing member 2, a speaker unit for left-side audio 3a, a speaker unit for right-side audio 3b, and an amplifier unit 4.

The television set main body 1 includes a display portion 11 on its front surface (the surface toward the Y1 direction). Moreover, the television set main body 1 is disposed such that its rear surface (the surface toward the Y2 direction) faces the wall 200. In addition, the television set main body 1 is secured to the wall 200 by the securing member 2. Furthermore, the television set main body 1 is a so-called thin-screen TV whose forward-rearward direction (Y direction) perpendicular or substantially perpendicular to the display portion 11 is thinly formed. The display portion 11 is constituted so as to display the screen images of broadcast television and the like. Moreover, the display portion 11 preferably is constituted by a liquid crystal display, for example.

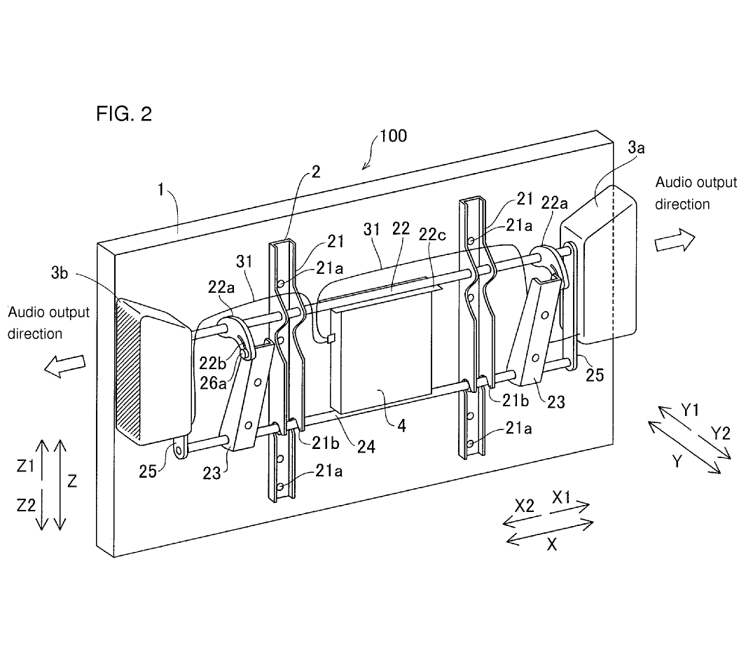

The securing member 2 is constituted so as to secure the television set main body 1 in the state of hanging on the wall. In addition, as is shown in FIG. 2, the securing member 2 includes a pair of TV-side securing members 21, a top-side securing member 22, a pair of wall-side securing members 23, a bottom-side securing member 24, and a pair of flat plate-shaped linking members 25. The pair of TV-side securing members 21, the top-side securing member 22, the pair of wall-side securing members 23, the bottom-side securing member 24, and the pair of linking members 25 are preferably made of steel, aluminum, or other metal, for example. Note that the TV-side securing members 21 and the top-side securing member 22 are one example of the “TV-side securing members”. Furthermore, the wall-side securing members 23 and the bottom-side securing member 24 are one example of the “wall-side securing members”.

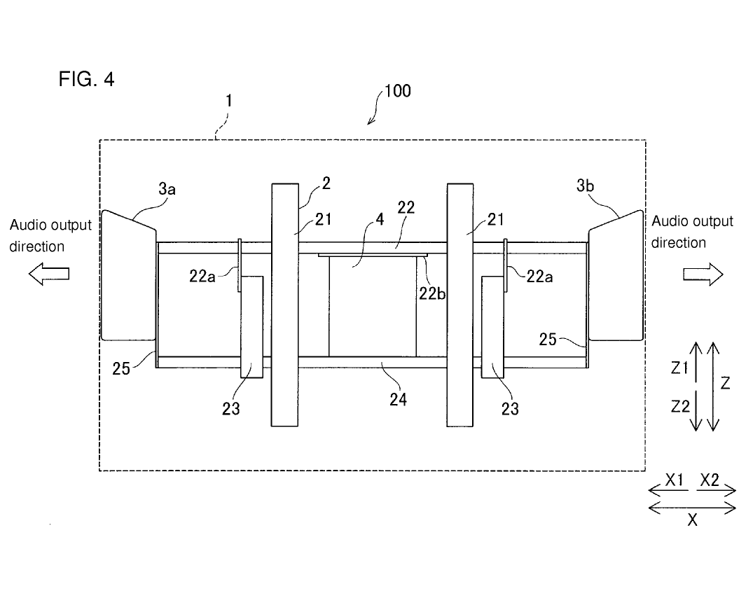

Moreover, as is shown in FIG. 4, the securing member 2 preferably has a lattice shape defined by the pair of TV-side securing members 21 extending substantially in the vertical direction (Z direction) and the top-side securing member 22 and bottom-side securing member 24 extending in the left-right direction (X direction). The pair of TV-side securing members 21 and the top-side securing member 22 are constituted so as to be attached to the television set main body 1. The pair of wall-side securing members 23 and the bottom-side securing member 24 are constituted so as to be attached to the wall 200. In addition, the securing member 2 is constituted such that the pair of TV-side securing members 21 and top-side securing member that are attached to the television set main body 1 are attached to the pair of wall-side securing members 23 and bottom-side securing member 24 that are attached to the wall 200, thus securing the television set main body 1 to the wall 200.

The pair of TV-side securing members 21 are arranged so as to extend substantially in the vertical direction (Z direction) as shown in FIG. 2. Furthermore, the pair of TV-side securing members 21 are attached to the rear surface of the television set main body 1 at a specified interval apart from each other in the left-right direction (X direction). The pair of TV-side securing members 21 are each secured to the television set main body 1 by screws at attachment portions 21a. Moreover, the pair of TV-side securing members 21 are constituted so as to each be attached to the wall 200 as a result of hooks 21b latching onto the bottom-side securing member 24.

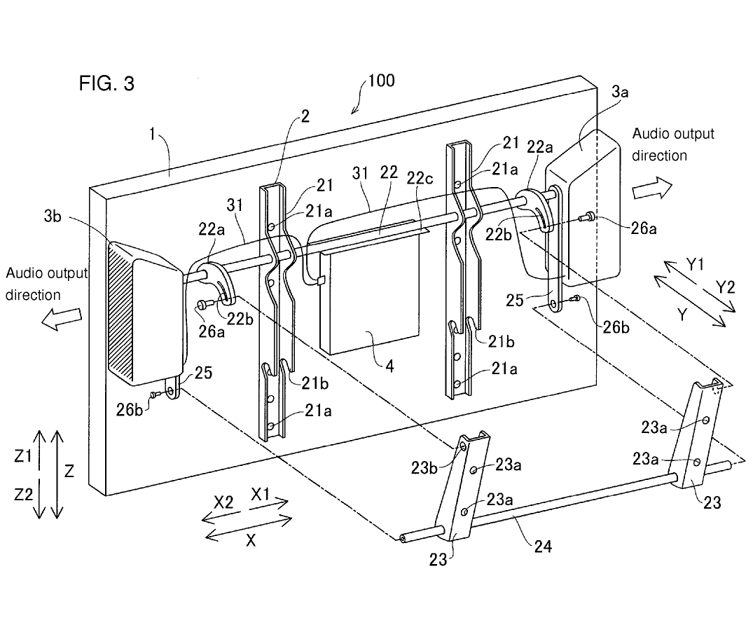

As is shown in FIG. 3, the top-side securing member 22 is arranged so as to extend in the left-right direction (X direction). In addition, the top-side securing member 22 is attached so as to be perpendicular or substantially perpendicular to the pair of TV-side securing members 21. Furthermore, a pair of angle-adjustment plates 22a are attached in a pivotable manner to the top-side securing member 22. The pair of angle-adjustment plates 22a are provided in order to adjust the pivoting angle of the television set main body 1 about the X axis (adjust the tilt angle in the forward-rearward direction). Each of the pair of angle-adjustment plates 22a has an arc-shaped slit 22b into which is inserted an angle-adjustment screw 26a that is screwed into a threaded hole 23b (see FIG. 3) in the corresponding wall-side securing member 23. Moreover, the constitution is such that the screw halt position of the angle-adjustment screw 26a with respect to the arc-shaped slit 22b can be adjusted in accordance with the pivoting angle of the television set main body 1 about the X axis. In addition, the top-side securing member 22 includes an amplifier attachment portion 22c. The amplifier attachment portion 22c is disposed between the pair of TV-side securing members 21 and is constituted such that the amplifier unit 4 is attached and secured thereto. Furthermore, the speaker units are attached to both the left and right ends of the top-side securing member 22. The speaker unit for left-side audio 3a is attached by a screw from the inside of the speaker unit for left-side audio 3a via the corresponding linking member 25 to the end portion of the top-side securing member 22 in the left direction (X1 direction). Likewise, the speaker unit for right-side audio 3b is attached by a screw from the inside of the speaker unit for right-side audio 3b via the corresponding linking member 25 to the end portion of the top-side securing member 22 in the right direction (X2 direction).

As is shown in FIG. 3, the pair of wall-side securing members 23 are arranged so as to extend substantially in the vertical direction (Z direction). Moreover, the pair of wall-side securing members 23 are attached to the wall 200 at a specified interval apart from each other in the left-right direction (X direction). The pair of wall-side securing members are each secured to the wall 200 by screw fastening at attachment portions 23a. In addition, the pair of wall-side securing members 23 are screw-fastened as a result of the pair of angle-adjustment plates 22a of the top-side securing member 22 being respectively screwed at the threaded holes 23b by the angle-adjustment screws 26a.

The bottom-side securing member 24 is arranged so as to extend in the left-right direction (X direction) as shown in FIG. 3. Furthermore, the bottom-side securing member 24 is attached so as to be perpendicular or substantially perpendicular to the pair of wall-side securing members 23. Moreover, the linking members 25 are screwed down onto both the left and right ends of the bottom-side securing member 24.

The pair of linking members 25 are arranged so as to extend substantially in the vertical direction (Z direction) as shown in FIG. 2. In addition, the pair of linking members 25 are constituted so as to link the top-side securing member 22 secured to the side of the television set main body 1 with the bottom-side securing member 24 secured to the side of the wall 200. The pair of linking members 25 link the top-side securing member 22 and the bottom-side securing member 24 substantially in the vertical direction (Z direction) at both ends in the left-right direction (X direction) of the top-side securing member 22 and the bottom-side securing member 24.

Here, in the first preferred embodiment, the speaker unit for left-side audio 3a and the speaker unit for right-side audio 3b are each preferably constituted so as to output stereo audio for the television set main body 1. The speaker unit for left-side audio 3a is constituted so as to output the left-side audio for the television set main body 1. The speaker unit for right-side audio 3b is constituted so as to output the right-side audio for the television set main body 1. Furthermore, as is shown in FIG. 1, the speaker unit for left-side audio 3a and the speaker unit for right-side audio 3b are each disposed so as to output audio in a direction parallel or substantially parallel to the display portion 11 of the television set main body 1. The speaker unit for left-side audio 3a is disposed so as to output audio in the direction to the left (X1 direction). The speaker unit for right-side audio 3b is disposed so as to output audio in the direction to the right (X2 direction). Moreover, the speaker unit for left-side audio 3a and the speaker unit for right-side audio 3b are each disposed in a space between the television set main body 1 and the wall 200.

In addition, the speaker unit for left-side audio 3a and the speaker unit for right-side audio 3b are each attached to the lattice-shaped securing member 2 (the top-side securing member 22). The speaker unit for left-side audio 3a and the speaker unit for right-side audio 3b are each disposed in a space between the television set main body 1 and the wall 200 and also in the vicinity of the outer edge portions of the rear surface of the television set main body 1. Furthermore, as is shown in FIG. 4, the speaker unit for left-side audio 3a and the speaker unit for right-side audio 3b are disposed such that, when viewed from the front, they are completely hidden behind the television set main body 1 (on the Y2 direction side) (such that they are not exposed from the television set main body 1). Moreover, the speaker unit for left-side audio 3a and the speaker unit for right-side audio 3b are each connected to the amplifier unit 4 via cable 31 as shown in FIG. 2.

The amplifier unit 4 is constituted so as to amplify the audio signal that is output from the television set main body 1 and provide output to the speaker unit for left-side audio 3a and the speaker unit for right-side audio 3b. In addition, the amplifier unit 4 is disposed in a space between the television set main body 1 and the wall 200 and also in a space within the lattice-shaped securing member 2 delimited in a lattice shape. The amplifier unit 4 is attached to the amplifier attachment portion 22c of the top-side securing member 22. Furthermore, the amplifier unit 4 is disposed in the space between the top-side securing member 22 and the bottom-side securing member 24 in the vertical direction (Z direction) and between the pair of TV-side securing members 21 in the left-right direction (X direction).

Next, an example of a procedure for assembling the television set 100 according to the first preferred embodiment will be described. First, the pair of TV-side securing members 21 and the top-side securing member 22 are attached to the rear surface (the surface toward the Y2 direction) of the television set main body 1 as shown in FIG. 3. The pair of TV-side securing members 21 and the top-side securing member 22 are secured to the television set main body 1 by screw-fastening at the attachment portions 21a of the pair of TV-side securing members 21.

Next, the speaker units and the linking members 25 are attached to the left and right of the top-side securing member 22. The speaker unit for left-side audio 3a is secured by screw-fastening from the inside of the speaker unit for left-side audio 3a with a linking member 25 being interposed to the end portion in the left direction (X1 direction) of the top-side securing member 22. Likewise, the speaker unit for right-side audio 3b is secured by screw-fastening from the inside of the speaker unit for right-side audio 3b with a linking member 25 being interposed to the end portion in the right direction (X2 direction) of the top-side securing member 22. Then, the amplifier unit 4 is screwed down and secured to the amplifier attachment portion 22c of the top-side securing member 22. Moreover, the cable 31 is used to connect the amplifier unit 4 to the speaker unit for left-side audio 3a and the speaker unit for right-side audio 3b. In addition, the amplifier unit 4 and the television set main body 1 are connected by cable (not shown).

Furthermore, the pair of wall-side securing members 23 and the bottom-side securing member 24 are attached to the wall 200. The pair of wall-side securing members 23 and the bottom-side securing member 24 are secured to the wall 200 by screw-fastening at the attachment portions 23a of the pair of wall-side securing members 23. Next, the hooks 21b of the pair of TV-side securing members 21 are latched onto the bottom-side securing member 24. Then, the pair of angle-adjustment plates 22a of the top-side securing member 22 are respectively screwed down to the wall-side securing members 23. The angle-adjustment screws 26a are used to screw down into the threaded holes 23b in the wall-side securing members 23, with the screw halt positions of the slits 22b in the angle-adjustment plates 22a being adjusted in accordance with the pivoting angle about the X axis of the television set main body 1. Then, screws 26b are used to secure the left and right linking members 25 and the bottom-side securing member 24. Thus, the television set 100 is assembled and secured to the wall 200 in the state of hanging on the wall.

In the first preferred embodiment, as was described above, by providing the speaker unit for left-side audio 3a and the speaker unit for right-side audio 3b in the space between the television set main body 1 and the wall 200 so as to output audio in the X direction which is parallel or substantially parallel to the display portion 11 of the television set main body 1, the thickness (length in the Y direction) of each of the speaker units for left-side audio 3a and the speaker unit for right-side audio 3b can be increased within the constraints of the space between the television set main body 1 and the wall 200 irrespective of the thickness of the television set main body 1. Therefore, even in cases where the television set main body 1 is made thin, it is possible to prevent any degradation of the quality of the sound that is output from the speakers.

Moreover, in the first preferred embodiment, as was described above, by attaching each of the speaker unit for left-side audio 3a and the speaker unit for right-side audio 3b to the lattice-shaped securing member 2, the space arising from the use of the lattice-shaped securing member 2 can be effectively utilized, which makes it possible to easily dispose the speaker unit for left-side audio 3a and the speaker unit for right-side audio 3b in the space between the television set main body 1 and the wall 200.

In addition, in the first preferred embodiment, as was described above, the television set main body 1 is secured to the wall 200 by attaching the pair of TV-side securing members 21 and the top-side securing member 22 to the pair of wall-side securing members 23 and the bottom-side securing member 24, and the speaker unit for left-side audio 3a and the speaker unit for right-side audio 3b are respectively attached to the pair of TV-side securing members 21 and the top-side securing member 22. This makes it possible to secure the television set main body 1 to the wall 200 by first attaching the television set main body 1, the speaker unit for left-side audio 3a, and the speaker unit for right-side audio 3b to the pair of TV-side securing members 21 and the top-side securing member 22 and then attaching them to the pair of wall-side securing members 23 and the bottom-side securing member 24. Therefore, the work of wiring the speaker unit for left-side audio 3a and the speaker unit for right-side audio 3b to the television set main body 1 and the like can be performed easily before securing to the wall 200. As a result, when the speaker unit for left-side audio 3a and the speaker unit for right-side audio 3b are to be installed between the television set main body 1 and the wall 200, this installation work can be performed efficiently.

As was described above, in the first preferred embodiment, furthermore, the amplifier unit 4 preferably is disposed in a space between the television set main body 1 and the wall 200 and also in a space within the lattice-shaped securing member 2 delimited in a lattice shape. This allows effective use of the space delimited in the lattice shape by the securing member 2 within the space between the television set main body 1 and the wall 200, which makes it possible to easily dispose the amplifier unit 4. Therefore, the quality of the sound output from the speaker unit for left-side audio 3a and the speaker unit for right-side audio 3b is improved with the use of the amplifier unit 4.

Moreover, in the first preferred embodiment, as was described above, the speaker unit for left-side audio 3a and the speaker unit for right-side audio 3b preferably are each disposed in a space between the television set main body 1 and the wall 200 and also in the vicinity of the outer edge portions of the rear surface of the television set main body 1. This makes it possible to prevent the sound being trapped in the space between the television set main body 1 and the wall 200, so the users are able to hear the audio output from the speaker unit for left-side audio 3a and the speaker unit for right-side audio 3b in a favorable state.

### Second Preferred Embodiment

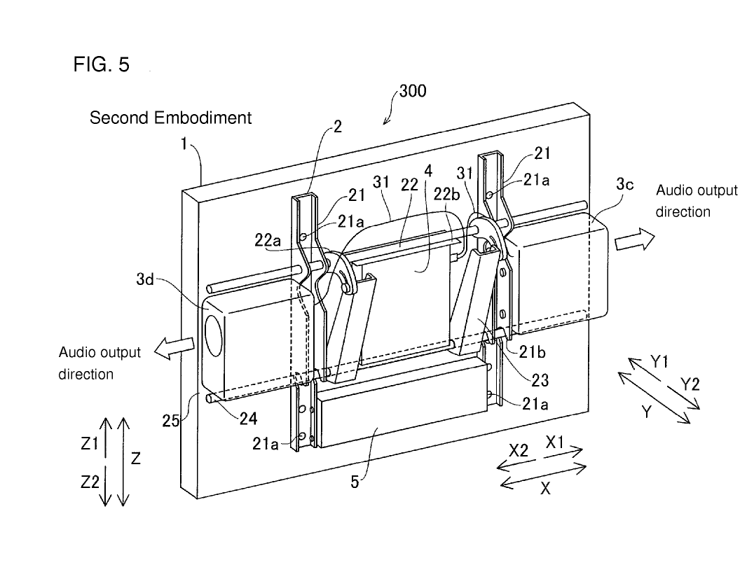

Next, the television set 300 according to a second preferred embodiment of the present invention will be described with reference to FIG. 5. In this second preferred embodiment, unlike the aforementioned first preferred embodiment, a constitution will be described in which a speaker unit for left-side audio and a speaker unit for right-side audio are each attached to TV-side securing members 21.

Here, in the second preferred embodiment, the television set 300 includes a television set main body 1, a securing member 2, a speaker unit for left-side audio 3c, a speaker unit for right-side audio 3d, an amplifier unit 4, and a subwoofer unit 5 as shown in FIG. 5. The television set main body 1 is disposed such that it hangs on the wall 200 with its rear surface (the surface toward the Y2 direction) facing the wall.

The speaker unit for left-side audio 3c and the speaker unit for right-side audio 3d are each constituted so as to output stereo audio for the television set main body 1. In addition, each of the speaker unit for left-side audio 3c and the speaker unit for right-side audio 3d includes an enclosure (not shown) and is constituted so as to efficiently provide audio output. Furthermore, the speaker unit for left-side audio 3c and the speaker unit for right-side audio 3d are each disposed so as to output audio in a direction parallel or substantially parallel to the display portion 11 of the television set main body 1 as shown in FIG. 5. The speaker unit for left-side audio 3c is disposed so as to output audio in the direction to the left (X1 direction). The speaker unit for right-side audio 3d is disposed so as to output audio in the direction to the right (X2 direction). Moreover, the speaker unit for left-side audio 3c and the speaker unit for right-side audio 3d are each disposed in a space between the television set main body 1 and the wall 200.

In addition, in the second preferred embodiment, the speaker unit for left-side audio 3c and the speaker unit for right-side audio 3d are each attached to the lattice-shaped securing member 2. The speaker unit for left-side audio 3c and the speaker unit for right-side audio 3d are respectively attached to the pair of TV-side securing members 21 that are attached to the television set main body 1. To elaborate this, the speaker unit for left-side audio 3c is secured by screws to the outside (the X1 direction side) of the TV-side securing member 21 toward the left direction (the X1 direction). Likewise, the speaker unit for right-side audio 3d is secured by screws to the outside (the X2 direction side) of the TV-side securing member 21 toward the right direction (the X2 direction).

Furthermore, the speaker unit for left-side audio 3c and the speaker unit for right-side audio 3d are each disposed in a space between the television set main body 1 and the wall 200 and also in a space within the lattice-shaped securing member 2 delimited in a lattice shape. The speaker unit for left-side audio 3c is disposed in the space delimited in the lattice shape by the left-side TV-side securing member 21, the top-side securing member 22, and the bottom-side securing member 24. Likewise, the speaker unit for right-side audio 3d is disposed in the space delimited in the lattice shape by the right-side TV-side securing member 21, the top-side securing member 22, and the bottom-side securing member 24.

The subwoofer unit 5 is constituted so as to provide supplemental output of audio in the low-frequency range within the audio that is output from the speaker unit for left-side audio 3c and the speaker unit for right-side audio 3d. Moreover, the subwoofer unit 5 is disposed in a space between the television set main body 1 and the wall 200 and also in a space within the lattice-shaped securing member 2 delimited in a lattice shape. The subwoofer unit 5 is disposed in a space that is below the bottom-side securing member 24 (toward the Z2 direction) and that is sandwiched between the pair of TV-side securing members 21 in the left-right direction (X direction). In addition, the subwoofer unit 5 is secured by screws to the TV-side securing members 21 at its both left and right ends. Furthermore, the subwoofer unit 5 is connected by cable (not shown) to the amplifier unit 4.

Note that the remainder of the constitution of the second preferred embodiment is preferably the same or substantially the same as that of the aforementioned first preferred embodiment.

As was described above, with the constitution of the second preferred embodiment as well, as in the aforementioned first preferred embodiment, as a result of the speaker unit for left-side audio 3c and the speaker unit for right-side audio 3d being provided in a space between the television set main body 1 and the wall 200, it is possible to prevent any degradation of the quality of the sound that is output from the speakers even in cases where the television set main body 1 is made thin.

As was described above, in the second preferred embodiment, furthermore, the speaker unit for left-side audio 3c and the speaker unit for right-side audio 3d are each disposed in a space between the television set main body 1 and the wall 200 and also in the space within the lattice-shaped securing member 2 delimited in a lattice shape. Consequently, the speaker unit for left-side audio 3c and the speaker unit for right-side audio 3d can easily be disposed by effectively utilizing the space delimited in the lattice shape by the securing member 2 within the space between the television set main body 1 and the wall 200.

Note that the other effects of the second preferred embodiment are the same as those of the aforementioned first preferred embodiment.

Note that the preferred embodiments disclosed herein merely constitute illustrative examples in all respects and should be considered to be nonrestrictive. The scope of the present invention is indicated not by the description of the preferred embodiments but rather by the scope of the claims and includes all modifications with an equivalent meaning to the scope of the claims and within the scope of the claims.

For instance, the first and second preferred embodiments provide non-limiting examples of constitutions in which the television set main body is secured to the wall by a securing member, but the present invention is in no way limited thereto. With the present invention, the television set main body needs not be secured to the wall by a securing member as long as it is disposed such that the rear surface of the television set main body faces the wall. For example, the television set main body may be placed on a TV stand or on the floor in a state in which the rear surface thereof faces the wall.

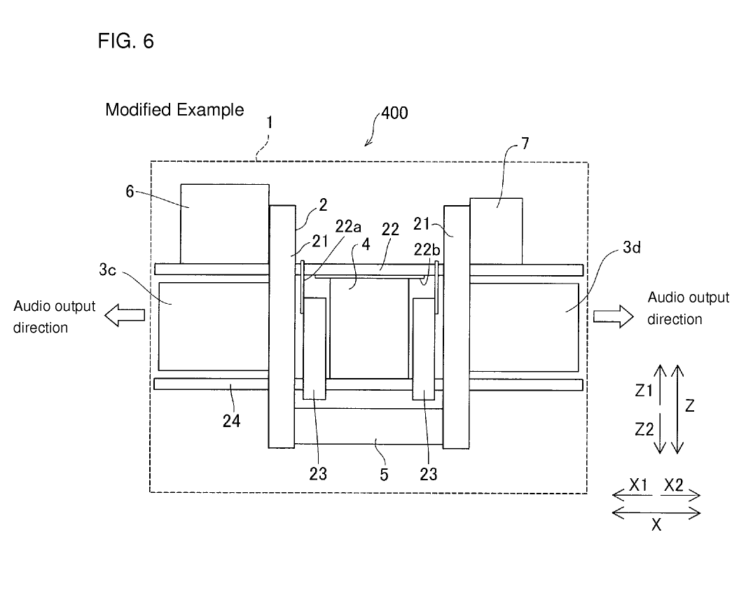

Moreover, the second preferred embodiment provides a non-limiting example of a constitution in which a speaker unit for left-side audio, a speaker unit for right-side audio, an amplifier unit, and a subwoofer unit are provided between the television set main body and the wall, but the present invention is in no way limited thereto. In the present invention, other audio equipment or recording equipment may also be disposed between the television set main body and the wall. For example, as in the modified example shown in FIG. 6, a television set 400 may be such that a Blu-ray Disc (BD) player 6 which provides video output and a hard disc drive (HDD) 7 which records video are disposed between the television set main body 1 and the wall 200. Note that the BD player 6 is one example of the “audio equipment”, while the HDD 7 is one example of the “recording equipment”. In addition, audio equipment other than the BD player or recording equipment other than the HDD may also be disposed between the television set main body and the wall. For instance, a BD recorder or other recording apparatus, set-top box (STB), streaming player or game machine or other audio equipment or recording equipment may also be disposed between the television set main body and the wall.

Furthermore, the first and second preferred embodiments provide non-limiting examples of constitutions in which the securing member is preferably made of steel or aluminum, but the present invention is in no way limited thereto. In the present invention, the securing member may be made of materials other than steel or aluminum. For example, the securing member may be made of metals other than steel or aluminum or may be formed of plastics or other resins.

Moreover, the first and second preferred embodiments provide non-limiting examples of constitutions in which the speaker unit for left-side audio and the speaker unit for right-side audio are disposed so as to output audio to the left and right directions, respectively, but the present invention is in no way limited thereto. In the present invention, as long as the speaker unit for left-side audio and the speaker unit for right-side audio are each disposed so as to provide output of audio in a direction parallel or substantially parallel to the display portion of the television set main body, the speaker unit for left-side audio and the speaker unit for right-side audio may each be disposed so as to output audio in a direction other than the left-right direction. For instance, the speaker unit for left-side audio and the speaker unit for right-side audio may also be disposed so as to provide output of audio in the upward direction or in the downward direction. In this case, it is preferable for the speaker unit for left-side audio and the speaker unit for right-side audio to be respectively disposed either in the upward direction at left and right in the vicinity of the outer edge portions of the television set main body or in the downward direction at left and right in the vicinity of the outer edge portions so as to coincide with the audio output direction.

In addition, the first and second preferred embodiments provide non-limiting examples of constitutions in which the wiring for the speaker unit for left-side audio and the speaker unit for right-side audio is disposed outside of the securing member, but the present invention is in no way limited thereto. In the present invention, it would also be possible for the securing member to have a hollow structure, thus allowing the wiring for the speaker unit for left-side audio and the speaker unit for right-side audio to pass through the interior of the securing member.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. (canceled)

2. A television set comprising:
a television set main body that includes a display portion on a front surface and that is disposed such that a rear surface faces a wall;
a speaker unit for left-side audio and a speaker unit for right-side audio provided on the television set main body; wherein
the speaker unit for left-side audio and the speaker unit for right-side audio are each disposed in a space between the television set main body and the wall so as to output audio in a direction parallel or substantially parallel to the display portion of the television set main body.

3. The television set according to claim 2, further comprising a lattice-shaped securing member that secures the television set main body to the wall; and
the speaker unit for left-side audio and the speaker unit for right-side audio are each attached to the lattice-shaped securing member.

4. The television set according to claim 3, wherein
the securing member includes TV-side securing members attached to the television set main body and wall-side securing members attached to the wall and is also constituted such that the television set main body is secured to the wall by attaching the TV-side securing members to the wall-side securing members; and
the speaker unit for left-side audio and the speaker unit for right-side audio are respectively attached to the TV-side securing members.

5. The television set according to claim 3, further comprising an amplifier unit that provides audio output to the speaker unit for left-side audio and the speaker unit for right-side audio; and
the amplifier unit is disposed in a space between the television set main body and the wall and also in a space within the lattice-shaped securing member delimited in a lattice shape.

6. The television set according to claim 3, wherein the speaker unit for left-side audio and the speaker unit for right-side audio are each disposed in a space between the television set main body and the wall and also in a space within the lattice-shaped securing member delimited in a lattice shape.

7. The television set according to claim 2, wherein the speaker unit for left-side audio and the speaker unit for right-side audio are each disposed in a space between the television set main body and the wall and also adjacent to outer edge portions of the rear surface of the television set main body.

8. The television set according to claim 2, further comprising audio equipment that provides video output or recording equipment that records video; and
the audio equipment or the recording equipment is disposed in a space between the television set main body and the wall.
